(19) United States
(12) Patent Application Publication
(10) Pub. No.: US 2015/0161737 A1
(43) Pub. Date: Jun. 11, 2015

(54) SYSTEM AND METHOD OF SETTLING CLAIMS OF INJURED VICTIMS

(71) Applicant: Thomas Danaher Harvey, Rockville, MD (US)

(72) Inventor: Thomas Danaher Harvey, Rockville, MD (US)

(21) Appl. No.: 14/103,568

(22) Filed: Dec. 11, 2013

(51) Int. Cl. G06Q 40/08; G06Q 50/18

(52) U.S. Cl. CPC G06Q 40/08; G06Q 50/18

(57) ABSTRACT

The present invention relates to a method of settling insurance claims of injured victims of dangerous objects such as firearms, ballistic weapons or other similar objects, using a system that stores and maintains dangerous object and insurer related information, such as serial number, ballistics/cartridge data, name of the insurer and maintaining confidentiality of ownership details.

### CROSS-REFERENCE TO RELATED APPLICATIONS

The present application claims priority from U.S. Provisional Patent Application No. 61/848,201, which application was filed Dec. 26, 2012, which application is currently pending, and which application and is incorporated herein by reference.

### BACKGROUND OF THE INVENTION

1. Field of the Invention

The present invention relates to a method of settling claims of injured victims of dangerous objects such as firearms, ballistic weapons or other similar objects, using a system that maintains dangerous object and insurer related information.

2. Background Art

The United States is witnessing an increase in the manufacture, import and use of dangerous objects such as firearms or other similar objects resulting in serious firearm-related incidents. The Annual Statistical Update 2013 of The United States Department of Justice indicates that the number of firearms manufactured over the last 10 years has increased from 2.9 million in 2001 to 6.5 million in 2011; about 4.8 million firearms have been imported in 2012, that is, an increase of about 197% over a decade. Also, statistics collected in the year 2011 in the United States of America show that victims of firearms, (based on National Crime Victimization Survey), were 467,321; the Federal Bureau of Investigation found that firearms were used in 68 percent of murders, 41 percent of robbery offences and in 21 percent of aggravated assaults.

Many insurance systems and methods exist to cover workplace injuries or car accidents, which try to ensure responsible behavior by car owners or employers. Such insurance systems and methods allow victims of car accidents or workplace injuries to claim compensation from the insurance system. There is a need to provide an insurance system and a method to cover injured victims of dangerous objects such as firearms, ballistic weapons or other similar objects, to ensure public safety, and to minimize risks in using dangerous objects and creating awareness about safeguarding dangerous objects. Currently there exist no such insurance methods or systems to offer compensation to victims of dangerous objects, such as firearms related injuries due to accidents, negligence or defective firearms or other misuses.

Many firearm owners have serious objections to revealing their ownership to government authorities creating an enforcement difficulty and a strong possibility of illegal evasion of a governmental insurance requirement. There exist no current systems that allow enforcement of an insurance requirement with the identity of the firearm owners not revealed to government authorities.

There are many inventions that collect and store firearms related information. The following provides a list of references:

US Pat. App. Pub 2011/0153637 to Bailey et al describes system and method for collecting, storing, and providing information related to firearms. More specifically, this invention tracks ownership and/or possession of a firearm from its manufacture onward (i.e., from cradle to grave) between and among registered firearm manufacturers, firearm sellers/dealers, individual gun owners, pawn shops, law enforcement agencies, government agencies and any other entity or individual stakeholder that may own and/or possess the firearm. The system may further authenticate firearm-related transactions, provide notifications to registered users, and enable local and global reports of loss, theft, and/or the use in a crime.

The above invention discloses an integrated database for information related to firearms and ownership. However the system described in the above invention does not maintain insurer information, which is required by an injured victim to identify the insurer, who may be under the insurance contract and/or law and are obliged to compensate the injured victims of dangerous objects such as firearms, ballistic weapons or other similar objects.

US Pat. App. Pub 2011/0225198 to Edwards et al describes systems and methods for linking multiple events involving firearms for correlating links between multiple events involving firearms to criminal investigation and prosecution through one or more databases relating to gang activity. Specifically, it leads to a method of linking multiple events involving firearms, by submitting event information data and firearms information data to a system database for multiple firearms events and thus, generating a query map that correlates data in the system database with a preselected geographical grid based upon one or more preselected matching criteria to one or more data entries for a selected event.

The above invention discloses a feature to identify firearm/object using ballistic data, but this, however, does not provide any method or feature to store insurer information to enable injured victims of firearms to obtain the insurer details, who may be under law obliged to settle the losses of injured victims of dangerous objects such as firearms, ballistic weapons or other similar objects.

There exist prior art references that disclose databases maintaining information related to firearms; ownership information; or that track firearms using ballistic data. However, there are no centralized systems or integrated databases or methods that maintain both firearm and insurer related information to facilitate compensation to injured victims of dangerous objects such as firearms, ballistic weapons or other similar objects, while concealing ownership information. Such a system and method, as disclosed in the present invention, will provide benefits to a significant number of injured victims of dangerous objects or firearm related incidents.

### BRIEF SUMMARY OF THE INVENTION

The present invention relates to a system and method of settling claims of injured victims of dangerous objects such as firearms, ballistic weapons or other similar objects, by insurance coverage regardless of the transfer of ownership; and with the identity of subsequent owners of the dangerous objects being concealed.

For purposes of this disclosure, the “system” more preferably comprises a computer system where one or more computer programs, stored in a computer memory, are executed by a microprocessor. The computer programs comprises a series of instructions that receive, process, and transform data into human readable information for use in business operations and decision making cycles. In the most preferred embodiments of the present invention, the system implements a computer implemented method for performing the various method steps described herein.

The most preferred embodiments of the system provide a system and method, including network connections and related communication devices, to create a link between one or more dangerous objects, the owner of the one or more dangerous objects, and the insurer who is responsible to may payments to victims who are injured by the one or more dangerous objects. The identify of the owner of the one or more dangerous objects is kept confidential and not revealed to any party except under certain circumstances. When a person is injured by the one or more dangerous objects, the injured person can contact the responsible insurer without having access to the identity of the owner of the one or more dangerous objects. This provides a method of compensating victims who are injured by the one or more dangerous objects without compromising the privacy of the owner of the one or more dangerous objects.

The system described in the present invention, is created by an entity hereinafter referred as “system creator.” The system creator is interested in making certain that injured victims of dangerous objects are compensated. The system creator may be outside insurance system but in a position to require the existence of the system or in some cases the system creator may be the originator itself, a producer of initial seller of the dangerous object. The system creator makes certain that insurers are qualified for their role. The system creator also makes certain the system is accurate, continually updated and is available to injured victims of dangerous objects and may be involved in the administration of claims. The system creator may also enforce the correct function of certain other entities in specific implementations.

The system disclosed in the present invention creates, maintains and mandates an information system or interface comprising a database to provide insurance coverage to injured victims of dangerous objects such as firearms, ballistic weapons or other similar objects. The system maintains information such as manufacturer, licensor, dealer, purchaser or importer name; dangerous object identifier/serial number of the dangerous object; name of the insurer; subsequent insurer; dates of responsibility of insurer for dangerous objects; other dangerous object related information such as scans of ballistics of dangerous objects that facilitate identification of serial number of dangerous objects involved in incidents. The system creator ensures that the system stays up-to-date and provides access to injured victims to enable administration of claims while keeping ownership of the dangerous object concealed. The system maintains records of qualified insurers, who can financially and otherwise compensate for losses of injured victims.

The invention also relates to a method of settling claims of injured victims of dangerous objects such as firearms, ballistic weapons or other similar objects, by identifying current insurer responsible for claim administration using ballistic data or any other dangerous object details. The insurer assumes the responsibility to provide claim compensation on losses caused by the dangerous object. The insurance is “no-fault” in nature to cover all incidents and does not require identification of the owner of the dangerous object after the payment of either one time or periodic premiums. The insurance company whose policy is subsisting on the date of the incident settles the insurance claim, without disclosing details of the victim to the owner or vice versa. Insurers remain responsible for future injuries until subsequent insurers assume responsibility for the dangerous object, no matter what the form of the transfer of ownership. The transfer of ownership of dangerous objects could be through a contract, loss, theft or use by an unauthorized person. Owners may remain anonymous to any extent allowed by the insurers and have no obligations under the system. Contracts with insurers may be made by owners or by anyone with an interest in facilitating the production, ownership or distribution of dangerous objects by inducing the insurers to accept responsibility for injuries caused by the dangerous objects.

### BRIEF DESCRIPTION OF THE SEVERAL VIEWS OF THE DRAWING

The summary of the present invention, as well as the detailed description is better understood when read in conjunction with the accompanying drawings that illustrate one or more exemplary embodiments of the present invention.

FIG. 1 illustrates a process flow in a general implementation of the present invention for settling claims of injured victims using a system;

FIG. 2 illustrates a process flow in a specific implementation of the present invention for settling claims of injured victims by insuring firearms with a system set up by a government or firearm regulator; and

FIG. 3 illustrates a process flow in a specific implementation of the present invention for settling claims of injured victims by insuring dangerous tools or equipment with a system set up by the producer and initial seller.

### REFERENCE NUMBERS USED IN DRAWINGS

The following numbering is used throughout drawing figures and detailed description to illustrate the present invention:

101 system creator

201 government or firearm regulator

102 an information system or an interface comprising of a database referred to as “system”

202 an information system or an interface comprising of a database referred to as “system”

302 an information system or an interface comprising of a database referred to as “system”

103 originator

203 firearm manufacturer or importer

303 producer and initial seller

104 transfer

105 insurer

106 owner

107 new insurer

108 subsequent insurer

109 accepts responsibility

110 owner (possibly multiple or none)

111 new insurer

112 subsequent insurer or current insurer

113 accepts responsibility

114 improper possessor

115 injured person or injured victim

116 current insurer at date of injury

204 imports or manufactures firearm

205 transfer

206 insurer

207 accepts responsibility

208 dealer or first owner

209 new insurer

210 subsequent insurer

211 accepts responsibility

212 owner (possibly multiple)

213 new insurer

214 subsequent insurer or current insurer

215 accepts responsibility

216 improper possessor

217 injured person or injured victim

218 current insurer at date of injury

304 transfer

305 insurer

306 dealer

307 new insurer

308 subsequent insurer

309 accepts responsibility

310 owner (possibly multiple)

311 new insurer

312 subsequent insurer or current insurer

313 accepts responsibility

314 improper possessor

315 injured person or injured victim

316 current insurer at date of injury

### DETAILED DESCRIPTION OF THE INVENTION

The present invention is a system and method of settling claims of injured victims of dangerous objects. An example of a dangerous object is a firearm, ballistic weapon or other similar object. In the present invention there exists a “system creator”, a person or entity that creates an information system or an interface comprising of a database of dangerous objects that can be linked to one or more owners. The system creator has an interest in ensuring compensation of losses to injured victims. The system creator may a person or entity other than an insurance company but still in a position to require the existence of the system or in some cases the system creator may be the originator itself, the producer or initial seller of the dangerous object. The system creator makes certain that insurers are qualified for their role. The system creator also makes certain the system is accurate, continually updated and is available to injured victims of dangerous objects and may be involved in the administration of claims. The system creator may also enforce the correct function of certain other entities in specific implementations.

The system creator sets up, manages and remains in charge of the information system or interface comprising of a database, hereinafter referred to as “system”. The system maintains dangerous object details which include dangerous object description, dangerous object identifier, dangerous object serial number, ballistic data, dangerous object type, etc. Dangerous object identifier may take various forms such as a serial number stamped on the dangerous object, a scan of a bullet fired by a firearm or the address of the location of fixed equipment.

The system creator ensures that originators register insured dangerous objects into the system. Originator of the dangerous object is a manufacturer, producer, importer, initial seller, licensor or an entity that brings the dangerous object or registers the dangerous object for the first time into the system. The originator insures the dangerous object with a qualified insurer. And the originators registers insurer related information into the system. The system creator makes certain that insurers are financially and otherwise qualified to take responsibility for the insured dangerous object. The system creator also makes certain the system is accurate, continually updated and available to injured victims; and the system creator may be involved in the administration of claims. An injured victim is a person who is killed, injured or suffers property loss caused by the dangerous object. The injured victim accesses the database using dangerous object identifier and date of incident to identify responsible insurer to settle claims.

The insurer is an entity, which is financially and otherwise responsible for compensating losses caused by the dangerous object. A responsible insurer is one who must receive and pay out valid claims to injured victims during the dates of responsibility for the dangerous object. The date of responsibility starts at the time when the insurer claims responsibility for the dangerous object and does not end until responsibility for the dangerous object is transferred to another insurer. The insurance is usually ‘no fault’ in nature, both to cover all incidents and to eliminate the need to reveal identities of owner or offender. Insurers will usually enter into contracts with owners of the dangerous object to limit their financial exposure. An owner is a person who holds, has title to or possession of a dangerous object. The privacy/confidentiality of the owner is protected by the system and the owner's obligations, if any, are not part of this system but come from contracts with insurers.

A first owner may be an individual or an entity that purchases only for distribution purposes. The contractual relation to the originator may vary depending on whether the owner is an individual or an entity.

The system maintains dates of responsibility of insurers for the dangerous object and dates of subsequent transfers of the responsibility for the dangerous object to new insurers. A subsequent transfer can be a proper transfer of the dangerous object from previous owner. The purchase by an individual owner or proper transfer of the dangerous object may be with a new subsequent insurer accepting responsibility and registering the insured dangerous object and/or insurer related information into the system; in which case the previous insurer is relieved of future responsibility. However, in the case where purchase by an individual owner or proper transfer of the dangerous object is without a new subsequent insurer the previous insurer accepts responsibility for the dangerous object.

A subsequent transfer may also be an improper transfer through loss, theft or use by an unauthorized person or anything in violation of the terms of the contract. An improper transfer is not allowed by a contract in effect by an insurer. In the case of violation of the contract with the insurer, improper transfer does not require change of owner or any action involving the dangerous object. Improper transfer does not relieve the insurer of responsibility, which includes receiving and paying of valid claims for injured victims during the dates of responsibility for the dangerous object. The date of responsibility starts at the time when the insurer claims responsibility for the dangerous object and does not end until the responsibility is transferred to another insurer.

The system provides access to injured victims to use dangerous object details and date of incident to identify the relevant insurer to settle claims for compensation of losses from the dangerous object. The victim identifies the insurer associated with the dangerous object. A number or other unique characteristic of a dangerous object allows an injured victim to access the name of the insurer responsible for the dangerous object. This is used by injured victims to access the system and obtain the identity of the insurer in order to make a claim. The victim can make a claim directly to the relevant insurer without involving the owner. The insurer whose policy is subsisting on the date of incident settles the claim of the insurance without disclosing details of the victim to the owner or vice versa.

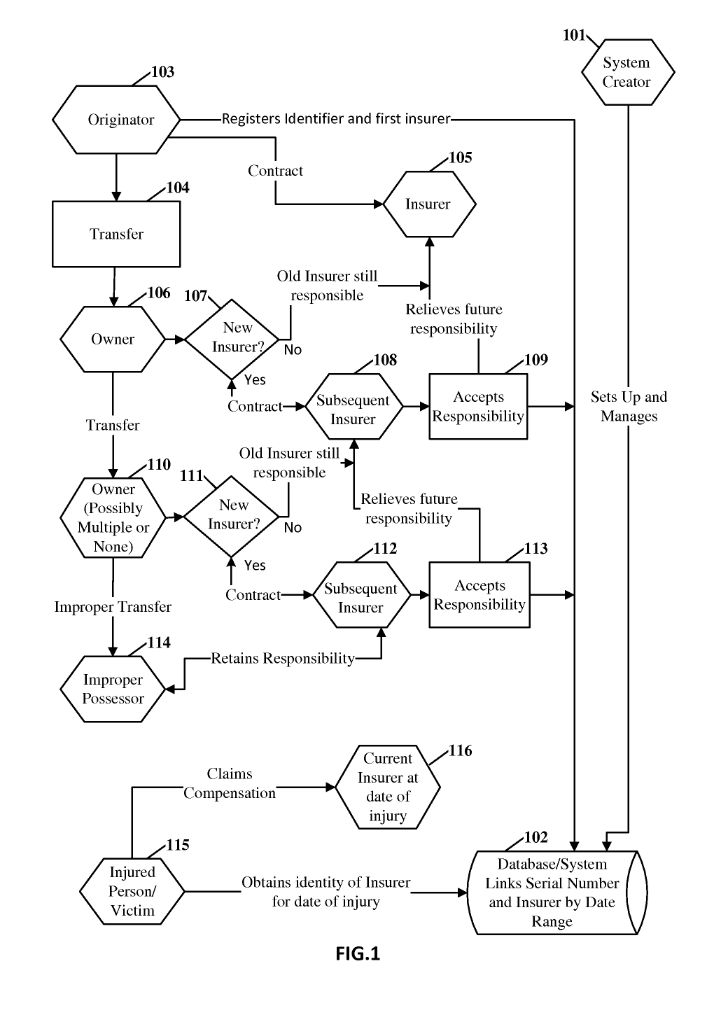

FIG. 1 is a system and method of settling claims for injured victims of dangerous object where the system creator 101, sets up, manages and remains in authority of an information system or interface comprising of a database 102, hereinafter referred to as “system”. The system 102 links insurers and object identifiers by date ranges. A dangerous object is manufactured, acquired or made ready for sale by the originator 103. The originator 103 registers the object identifier, dangerous object details and the first insurer 105 in the system 102. The first insurer 105 accepts responsibility for the dangerous object. The dangerous object could be transferred 104 to an owner 106. If the first owner 106 does not engage a new insurer 107, then previous insurer 105 is still responsible for the dangerous object. However, if the first owner 106 engages a new insurer 107, then the new insurer 107 undertakes a contract to become the subsequent insurer 108 who accepts responsibility 109 for the dangerous object, register subsequent insurer 108 related information into the system 102, and further relieves future responsibility of previous insurer 105.

There may be any number of additional transfers to possibly multiple owners 110, who may engage a new insurer 111. If, the new insurer 111 undertakes a contract to become the subsequent insurer 112 who accepts responsibility 113 for the dangerous object, registers subsequent insurer 112 related information into the system 102, and further relieves future responsibility of previous insurer 108. However, if the owner 110 does not engage a new insurer 111, then the previous insurer, who is a subsequent insurer 108, is still responsible for the dangerous object.

There may be an improper transfer to an improper possessor 114, through loss, theft or use by an unauthorized person or anything in violation of the terms of the contract. In the case of an improper transfer, the subsequent insurer 112, who is the current insurer 112 retains responsibility for the dangerous object and the current insurer 112 is not relieved from the responsibility for the dangerous object.

The injured victim 115 obtains the identity of the insurer for date of injury from the system 102 that links dangerous object details such as the serial number and insurer by date range. The current insurer at date of injury 116 settles claims and compensates for losses of injured victim 115.

The advantages from the present invention as exemplified above, provides assurance to persons outside the system 102 or the general public that all dangerous objects in the system 102 are covered by insurance. The identity of owners need not be revealed to other owners, the system creator 101 or insurers. The identity of injured victims of dangerous objects, making claims need only be revealed to responsible current insurer. Insurers can place contractual obligations on owners including payment of premiums as a condition of allowing transfer under a currently applicable contract. Such contractual obligations enable owners to act responsibly, ensure public safety; minimize risks in using and creating awareness about safeguarding dangerous objects. The system creator 101 can oversee payment of claims by regulating only the insurers. The only requirement imposed by the system 102 is to require that an insurer accepts responsibility for the dangerous object, and that responsible insurer continues as specified by the system 102. Injured victim 115 of dangerous object can make claims for compensation regardless of the possibility of improper transfer.

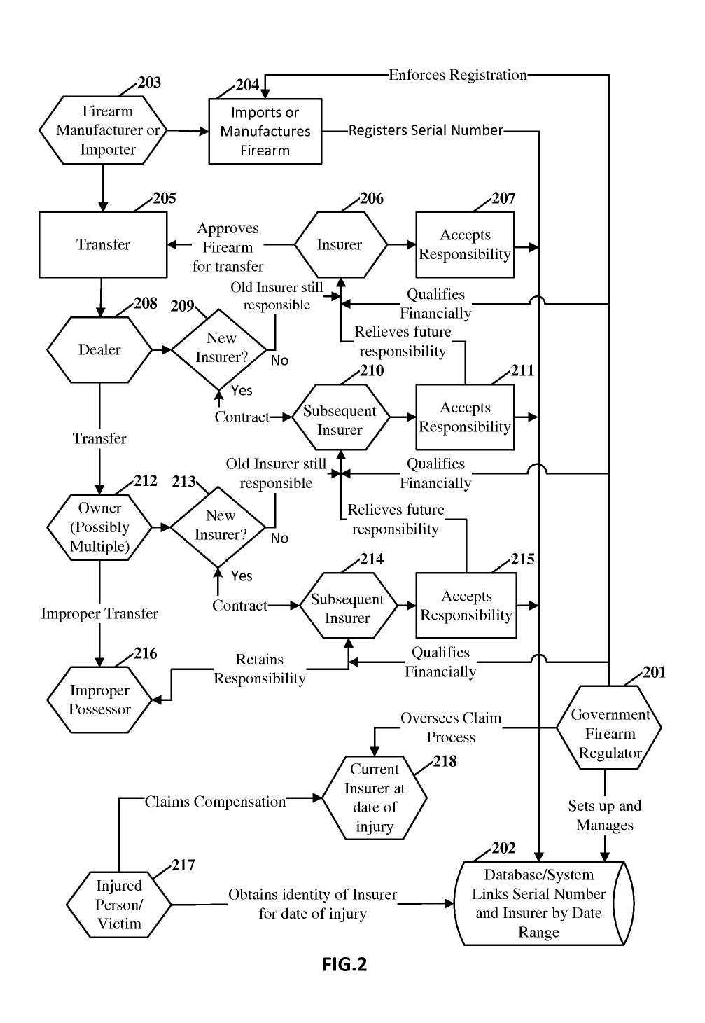

FIG. 2 is a system and method of settling claims for injured victims wherein a government or a firearm regulator 201, sets up, manages and remains in authority of an information system or an interface comprising of a database 202, hereinafter referred to as “system”. The system 202 links insurers and dangerous object identifier or serial number by date ranges. An example of the dangerous object is a firearm, which is manufactured, acquired or made ready for sale by the firearm manufacturer or importer 203. The firearm manufacturer or importer 203, is an entity which manufactures or imports firearms 204, and registers firearm details including firearm identifier or serial number in the system 202. The government or a firearm regulator 201 enforces firearm manufacturer or importer 203, to register firearms, into the system 202. The government or a firearm regulator 201 qualifies one or more insurers 206, who are financially qualified, into the system 202. An insurer 206 accepts responsibility 207 and registers insurer 206 related information in the system 202. The government or a firearm regulator 201 ensures that insurer 206 is financially qualified. A firearm manufacturer or importer can transfer 205, only after an insurer 206 accepts responsibility for a firearm.

The firearm manufacturer or importer 203 transfers 205 a firearm to the first owner or dealer 208. The first owner or dealer 208 may engage a new insurer 209, which is qualified by the government or a firearm regulator 201; in which case the firearm manufacturer or importer 203, may require a contract to be executed between the first owner or dealer 208 and a subsequent insurer 210. The subsequent insurer 210 accepts responsibility 211 and registers insurer 210 related information in the system 202. The government or a firearm regulator 201 ensures that insurer 210 is financially qualified. When the subsequent insurer 210 accepts responsibility 211 of the firearm, the previous insurer 206 is not responsible for future injuries occurring after the relevant date. When the first owner or dealer 208 does not engage a new insurer 209, then the previous insurer 206 remains responsible of the firearm.

There may be any number of additional transfers to possibly multiple owners 212, who may engage a new insurer 213, who is financially qualified by the government or a firearm regulator 201. Then, the new insurer 213 undertakes a contract to become the subsequent insurer 214 who accepts responsibility 215 for the firearm, registers subsequent insurer 214 related information into the system 202, and further relieves future responsibility of the previous insurer 210. The government or a firearm regulator 201 ensures that insurer 214 is financially qualified. However, if the owner 212 does not engage a new insurer 213, then the previous insurer, who is a subsequent insurer 210, is still responsible for the firearm.

There may be an improper transfer to an improper possessor 216, through loss, theft or use by an unauthorized person or anything in violation of the terms of the contract. In the case of an improper transfer, the subsequent insurer 214, who is the current insurer 214 retains responsibility for the firearm, and the current insurer 214 accepts responsibility 215 of the firearm.

The injured victim 217 obtains the identity of insurer for date of injury from system 202 that links the firearm related information such as the serial number and insurer by date range. The current insurer at date of injury 218 settles claims and compensates for losses of injured victim 217. The process for claim compensation of injured victim 217, is overseen by the government or a firearm regulator 201.

The advantages from the present invention as exemplified above and in FIG. 2, provides assurance to persons outside the system 202 or the general public that all dangerous objects such as firearms, in the system are covered by insurance. A government or a firearm regulator 201 can oversee payment of claims by regulating only the insurers. The only requirement imposed by the system and enforced by the government or a firearm regulator 201 on the firearm manufacturer or importer 203 is to require that a qualified insurer accepts responsibility for the firearm. Injured victims can make claims regardless of the possibility of improper transfer. Insurers can place contractual obligations on owners including payment of premiums as a condition of allowing transfer under a currently applicable contract. Such contractual obligations enable owners to act responsibly, ensure public safety; minimize risks in using and creating awareness about safeguarding firearms. The government or a firearm regulator 201 does not have to directly interact with owners other than the firearm manufacturer or importer 203 and avoid legal, constitutional or political problems.

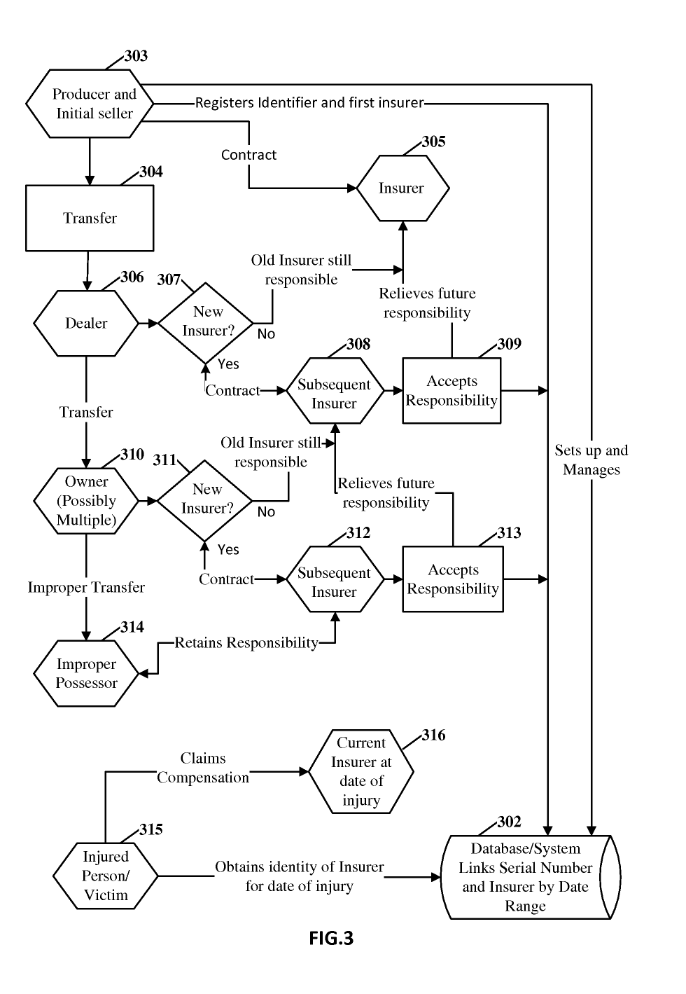

FIG. 3 is a system and method of settling claims for injured victims wherein the producer and initial seller 303, sets up and oversees an information system or an interface comprising of a database 302, hereinafter referred to as “system”. The system 302 links insurers and object identifier or serial number by date ranges. An example of the dangerous object is a dangerous tool or equipment, that is manufactured, acquired or made ready for sale by the producer and initial seller 303.

The producer and initial seller 303 registers the serial number, dangerous object identifier, dangerous object details and the first insurer 305 related information in the system 302. The first insurer 305 accepts responsibility for the dangerous tool or equipment. The dangerous tool or equipment may be transferred 304 to dealer 306. If the dealer 306 does not engage a new insurer 307, then previous insurer 305 is still responsible for the dangerous tool or equipment. However, if the dealer 306 engages a new insurer 307, then the new insurer 307 undertakes a contract to become the subsequent insurer 308, who accepts responsibility 309 for the dangerous tool or equipment, registers subsequent insurer 308 related information into the system 302, and further relieves future responsibility of previous insurer 305.

There may be any number of additional transfers to possibly multiple owners 310, who may engage a new insurer 311. Then, the new insurer 311 undertakes a contract to become the subsequent insurer 312 who accepts responsibility 313 for the dangerous tool or equipment, registers subsequent insurer 312 related information into the system 302 and further relieves future responsibility of previous insurer 308. However, if the owner 310 does not engage a new insurer 311, then the previous insurer, who is a subsequent insurer 308, is still responsible for the dangerous tool or equipment.

There may be an improper transfer to an improper possessor 314, through loss, theft or use by an unauthorized person or anything in violation of the terms of the contract. In the case of an improper transfer, the subsequent insurer 312, who is the current insurer 312 retains responsibility for the dangerous tool or equipment and the current insurer 312 is not relieved from the responsibility for the dangerous tool or equipment.

The injured victim 315 obtains the identity of insurer for date of injury from system 302 that links the serial number and insurer by date range. The current insurer at date of injury 316 settles claims and compensates for losses of injured victim 315.

The advantages from the present invention as exemplified above, provides assurance to persons outside the system 302 or the general public that all dangerous tool or equipment in the system 302 are covered by insurance. The only requirement imposed by the system 302, and enforced by the producer and initial seller 303, on the owners is to require, that qualified insurers accept responsibility for the insured dangerous tools or equipment. The producer and initial seller 303 does not have to directly interact with subsequent owners. The identity of an owner does not have to be reported to anyone other than, if required by contract, to the current insurer in order for a transfer to take place to that owner. The identity of an owner does not have to be revealed to anyone to make, process or pay a claim. Injured person 315 can make claims regardless of the possibility of improper transfer.

1. A system for settling claims of injured victims comprising:
a plurality of dangerous object details;
an originator of the dangerous object;
an insurer of the dangerous object;
an owner of the dangerous object;
at least one date of purchase for the dangerous object;
a subsequent transfer of the dangerous object; and
an information system or an interface to link insurer and dangerous object identifier.

2. The system for settling claims of injured victims of claim 1 wherein the system is created, maintained, updated and made available for settling claims of at least one injured victim by at least one of: a system creator; an entity other than an insurance company; a regulator; a producer; an initial seller of the dangerous object; and an insurance company.

3. The system for settling claims of injured victims of claim 1 is an information system or an interface comprising of a database for settling claims of injured victims.

4. The system for settling claims of injured victims of claim 1 wherein the said dangerous object is a firearm, ballistic weapon, or other similar objects and/or the dangerous object details comprising dangerous object description, dangerous object identifier, dangerous object serial number, ballistic data, dangerous object type, other details of the dangerous object, or a combination thereof.

5. The system for settling claims of injured victims of claim 1 wherein the said originator of the dangerous object is a manufacturer, producer, importer, initial seller, licensor or similar entity that brings the dangerous object into the system.

6. The system for settling claims of injured victims of claim 1 wherein the said insurer of the dangerous object is an entity, which is responsible for compensating losses caused by the dangerous object during the dates of responsibility for the dangerous object.

7. The system for settling claims of injured victims of claim 1 wherein the said owner of the dangerous object is a person who holds, has title to or possession of the dangerous object, and the privacy of owner is protected by the system and owner's obligations, if any, are not part of this system but come from contracts with insurers.

8. The system for settling claims of injured victims of claim 6 wherein the said dates of purchase of the dangerous object comprising date of first sale of the dangerous object and/or date of subsequent sale or transfer of the dangerous object and/or dates of responsibility of insurers for the dangerous object which starts at the time the insurer claims responsibility for the dangerous object and does not end until subsequent transfer of the dangerous object.

9. The system for settling claims of injured victims of claim 8 wherein said subsequent transfer of the dangerous object can be a proper transfer of the dangerous object from previous owner, or the said subsequent transfer of the dangerous object can be an improper transfer through loss, theft or use by an unauthorized person or anything in violation of the terms of the contract.

10. The system for settling claims of injured victims of claim 9 wherein the purchase or proper transfer of the dangerous object may be with a new subsequent insurer accepting responsibility for the dangerous object and relieving previous insurer from the responsibility for the dangerous object and/or the purchases or proper transfer of the dangerous object may be with previous insurer accepting responsibility for the dangerous object.

11. The system for settling claims of injured victims of claim 9 wherein said improper transfer does not relieve previous insurer from the responsibility for the dangerous object.

12. The system for settling claims of injured victims of claim 1 wherein the said information system or interface allows a victim to use dangerous object details and date of incident to obtain relevant insurer for compensation of losses from the dangerous object.

13. A method of settling claims of injured victims comprising:
a) a system having details of dangerous objects or other similar objects;
b) the originator registers the insured dangerous object and the first insurer details into t he system;
c) the first owner identifies responsible insurer for the said dangerous object and registers updated details into the system;
d) subsequent transfers of the said dangerous object is registered into the system; and
e) a victim identifies responsible insurer.

14. The method of settling claims of injured victims as in claim 13 wherein the said originator identifies an insurer for the dangerous object and registers insured dangerous object and/or insurer related details into the system and/or thereby allowing a victim to use date of incident, dangerous object details to obtain relevant insurer to settle claims from dangerous object related losses or injuries.

15. The method of settling claims of injured victims as in claim 13 wherein the said first owner purchases the dangerous object from an originator; the first owner engages a new insurer or previous insurer who accepts responsibility for the purchased dangerous object and/or if the new insurer accepts responsibility, the previous insurer is relieved from future responsibility for the dangerous object and/or thereby allowing a victim to use date of incident, dangerous object details to obtain relevant insurer to settle claims from dangerous object related losses or injuries.

16. The method of settling claims of injured victims as in claim 13 wherein the said subsequent transfer of the dangerous object can be a proper transfer of the dangerous object from previous owner and/or the said subsequent transfer can be an improper transfer through loss, theft or use by an unauthorized person or anything in violation of the terms of the contract.

17. The method of settling claims of injured victims as in claim 16 wherein the said subsequent transfer is a proper transfer to a new owner; the said new owner engages a new insurer or previous insurer who accepts responsibility for the purchased dangerous object and/or if the new insurer accepts responsibility, the previous insurer is relieved from future responsibility for the dangerous object and/or thereby allowing a victim to use date of incident, dangerous object details to obtain relevant insurer to settle claims from dangerous object related losses or injuries.

18. The method of settling claims of injured victims as in claim 16 wherein the said subsequent transfer is an improper transfer, which does not relieve the responsibility of previous insurer to settle claims from losses or injuries from the dangerous object and/or thereby allowing a victim to use date of incident, dangerous object details to obtain relevant insurer to settle claims from dangerous object related losses or injuries.
